(19) United States
(12) Patent Application Publication
(10) Pub. No.: US 2005/0108077 A1
(43) Pub. Date: May 19, 2005

(54) System for separating managed services technology from service labor provider

(76) Inventors: Thomas P. Capotosto, Austin, TX (US); Thomas G. Kunz, Austin, TX (US); David R. Ornelas, Austin, TX (US)

Correspondence Address: HAMILTON & TERRILE, LLP, P.O. BOX 203518, AUSTIN, TX, 78720, US

(21) Appl. No.: 10/831,790

(22) Filed: Apr. 26, 2004

Related U.S. Application Data
(60) Provisional application No. 60/520,738, filed on Nov. 17, 2003.

(51) Int. Cl. G06F 17/60

(52) U.S. Cl. 705/9

(57) ABSTRACT

A method for separating labor services from a managed service provider which includes providing the managed service provider with a service collaboration manager, interfacing with a service customer via the service collaboration manager, interfacing with a labor service provider via the service collaboration manager, and separating the labor service provider from the service collaboration manager.

### RELATED APPLICATIONS

The present application claims priority from U.S. Provisional Patent Application Ser. No. 60/520,738 entitled “Disaggregation of Services Into Building Blocks,” filed on Nov. 17, 2003, and incorporated herein by reference.

### BACKGROUND OF THE INVENTION

1. Field of the Invention

The present invention relates to managed services and more particularly to separating managed service technology from service labor providers.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

With the proliferation of information handling systems, especially within large scale information handling system installations, an important issue relates to the service and support of the large scale information handling system installations (i.e., installations in which more than a few information handling systems are supported by a single entity. The entity that services and supports such an installation is often referred to as a managed service provider. Managed services, or life-cycle services generally include deployment services and asset services. More specifically, managed services include some or all of asset deployment and installation services, asset management services (including, e.g., both asset tracking and asset moving services), asset maintenance services and asset retirement services.

A managed service provider provides a customer with an ability to procure, deploy, support and manage information handling system technologies across the life cycle of the information handling systems. Issues relating to managed services include logistics information management and asset utilization while providing quality service delivery and a favorable customer experience.

Known managed service providers generally couple the managed services technology with service labor. Alternately, service labor has been provisioned in an ad hoc staff augmentation fashion.

### SUMMARY OF THE INVENTION

In accordance with the present invention, a managed service system which provides the ability to easily utilize skilled and unskilled labor pools as part of a total service solution, regardless of geographic location is disclosed. The managed services system provides interchangeability of service providers through standardized interfaces, simplification of tasks, ownership of customer interfaces, ownership of information and ownership of service delivery technology. Additionally, the managed services system provides the ability to easily leverage service delivery resources based on skill and cost. For example, by extending a help disk terminal via a web interface, help desk resources become immediately available at any time from any location in the world, thus allowing the managed services provider to readily tap into specialized skills, language support, lowest cost providers, etc.

The present invention provides a purposeful isolation of service technology from service labor providers. Additionally, the managed services system provides for purposeful ownership of important control points with a customer so as to allow for addition or replacement of service labor providers as part of a managed services solution. These control points might include physical interfaces, data flow and a custom information repository. The managed services system provides a centralized technology infrastructure that may be extended across a public network to reach geographically diverse labor providers.

Such a system allows for easy incorporation of geographically diverse labor providers. The labor providers may be dynamically selected based upon criteria such as labor provider skills, labor provider location, and labor provider cost as well as addressing customer desire. Such a system also allows a managed service provider to easily replace a service labor provider such that hard dependencies are minimized. Thus, risks associated with sole sourcing and business disruption due to labor provider transitions are minimized. Additionally, desired labor service provider skills (such as technical skills or language skills) can be accessed as necessary for a particular managed service item. Additionally, such a system allows for retention and application of all technology and process improvements that are related to any service engagement.

In one embodiment, the invention relates to a method for separating labor services from a managed service provider which includes providing the managed service provider with a service collaboration manager, interfacing with a service customer via the service collaboration manager, interfacing with a labor service provider via the service collaboration manager, and separating the labor service provider from the service collaboration manager.

In another embodiment, the invention relates to an apparatus for separating labor services from a managed service provider which includes means for providing the managed service provider with a service collaboration manager, means for interfacing with a service customer via the service collaboration manager, means for interfacing with a labor service provider via the service collaboration manager, and means for separating the labor service provider from the service collaboration manager.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a schematic block diagram of a system for managing services.

FIG. 2 shows a schematic block diagram of the operation of a system for managing services.

FIG. 3 shows a system block diagram of an information handling system which is used within and serviced via a system for managing services.

FIG. 4 shows a block diagram of a managed services document schema.

FIGS. 5A, 5B and 5C, generally referred to as FIG. 5, show a block diagram of a managed services document incident schema.

FIGS. 6A and 6B, generally referred to as FIG. 6, show a block diagram of a managed services service incident schema.

FIG. 7 shows a block diagram of a managed services dispatch schema.

FIG. 8 shows a block diagram of a managed services dispatch reply schema is shown.

FIGS. 9A and 9B show block diagrams of service document flow.

### DETAILED DESCRIPTION

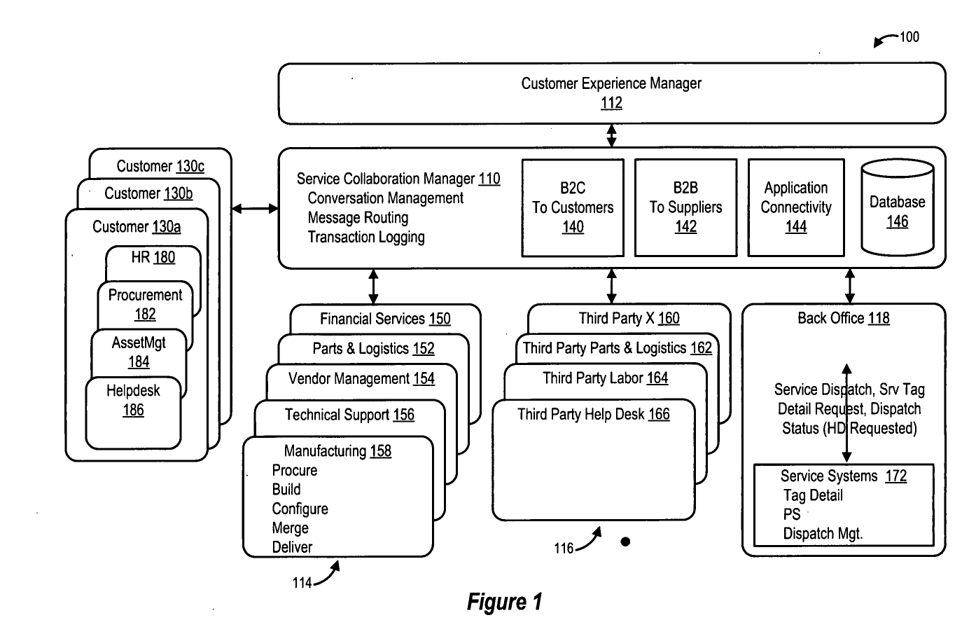

Referring to FIG. 1, a schematic block diagram of a system for managing services 100 within a managed services environment is shown. The system for managing services 100 enables the disaggregation of service components within the system for managing services. By enabling the disaggregation into service components, the system allows for the expansion of a potential service supplier pool, service supplier transparency, service supplier interchangeability and service supplier diversification.

The system for managing services 100 includes a service collaboration manager module 110, a customer experience manager module 112, a plurality of manufacturer modules 114, a plurality of third party service supplier modules 116 and a back office module 118. Customers 130a, 130b, 130c interact with the system via the service collaboration manager module 110.

The service collaboration manager module 110 provides a conversation management function, a message routing function and a transaction logging function. The service collaboration manager module 110 includes a managed services provider to customer (B2C) module 140 a managed services provider to supplier (B2B) module 142, an application connectivity module 144 and a database module 146.

The plurality of managed services provider modules 114 include a financial services module 150, a parts & logistics module 152, a vendor management module 154, a technical support module 156 and a manufacturing module 158.

The plurality of third party service supplier modules 116 include a third party X module 160 (which represents any type of third party service), a third party parts & logistics module 162, a third party labor module 164 and a third party help desk module 166.

The back office module 118 performs a plurality of functions. More specifically, the back office module 118 enables access between back office modules and the service collaboration manager module 110. The back office module provides a service dispatch function, an SRV tag detail request function as well as dispatch status function. The back office module 118 includes a service systems module 172.

Each customer 130 may perform one or more of a plurality of functions internally within the customer. For example, a customer may perform one or more of a human resources function 180, a procurement function 182, an asset management function 184 and a help desk function 186. Some customers may perform none of these functions internally and thus the managed service provider performs these functions for the customer.

Accordingly, the system for managing services 100 enables a managed service provider with the ability to easily utilize skilled and unskilled labor pools as part of a total service solution, regardless of geographic location of the labor service provider disclosed. The managed services system provides interchangeability of service providers through standardized interfaces, simplification of tasks, ownership of customer interfaces, ownership of information and ownership of service delivery technology. Additionally, the managed services system 100 provides the ability to easily leverage service delivery resources based on skill and cost. For example, by extending a help desk terminal via a web interface, help desk resources become immediately available at any time from any location in the world, thus allowing the managed services provider to readily tap into specialized skills, language support, lowest cost providers, etc.

The system for managing services 100 provides a purposeful isolation of service technology from service labor providers. Additionally, the system for managing services 100 provides for purposeful ownership of important control points with a customer so as to allow for addition or replacement of service labor providers as part of a managed services solution. These control points include physical interfaces, data flow and a customer information repository. The system for managing services provides a centralized technology infrastructure that may be extended across a public network to reach geographically diverse labor providers.

Such a system allows for easy incorporation of geographically diverse labor providers. The labor providers may be selected based upon criteria such as labor provider skills, labor provider location, and labor provider cost as well as addressing customer desire. Such a system also allows a managed service provider to easily replace a service labor provider such that hard dependencies are minimized. Thus, risks associated with sole sourcing and business disruption due to labor provider transitions are minimized. Additionally, desired labor service provider skills (such as technical skills or language skills) can be accessed as necessary for a particular managed service item. Additionally, such a system allows for retention and application of all technology and process improvements that are related to any service engagement.

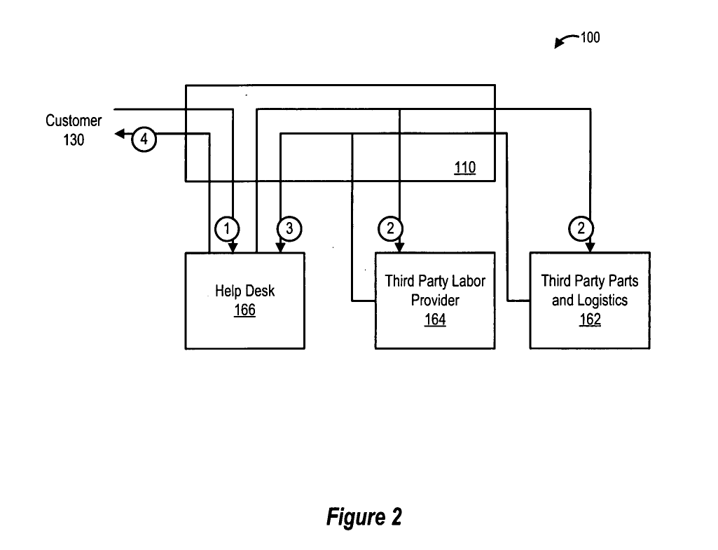

Referring to FIG. 2, a schematic block diagram one example of the operation of the separating labor service providers within a system for managing services is shown. More specifically, when a customer 130 desires access to a help desk function within the system for managing services 100 to resolve a customer issue, the customer 130 contacts the service collaboration manager 110 via a well defined interface (step 1). The service collaboration manager 110 then in turn communicates with a labor service provider which is providing the help desk function 166 via another well defined common interface. The help desk service provider 166 analyzes the issue raised by the customer and may determine, for example, that the customer needs a new hard drive for its information handling system.

The help desk service provider 166 communicates with a third party labor provider 164 and a third party parts and logistics service provider 162 via the service collaboration manager 110 using the well defined common interface (step 2). The third party labor provider 164 and the third party parts and logistics service provider 162 then perform the service item indicated by the help desk service provider 166, e.g., replacing a customer hard drive. When the third party labor provider 164 and the third party parts and logistics service provider 162 complete the installation of the new hard drive, then the third party labor provider 164 and the third party parts and logistics service provider 162 communicate with the help desk service provider 166 via the service collaboration manager 110 using the well defined common interface (step 3). The help desk service provider 166 then communicates with the customer via the service collaboration manager to determine whether the issue has been resolved (step 4). If so, then the help desk service provider 166 closes the item corresponding to the customer issue. The third party labor provider 164 and the parts and logistics provider 162 may or may not be the same third party provider.

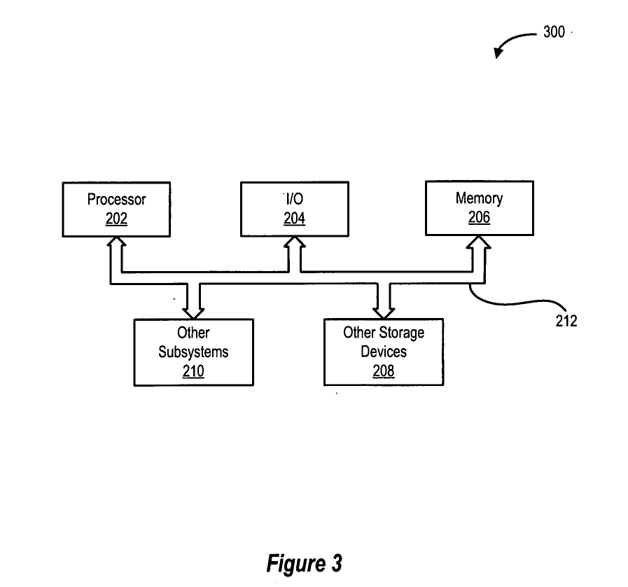

Referring to FIG. 3, a system block diagram of an information handling system 300 which is used within and serviced via a system for managing services 100 is shown. The information handling system 300 includes a processor 302, input/output (I/O) devices 304, such as a display, a keyboard, a mouse, and associated controllers, a non-volatile memory 306 such as a hard disk drive, and other storage devices 308, such as a floppy disk and drive and other memory devices, and various other subsystems 310, all interconnected via one or more buses 312.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

The well defined customer interface includes a plurality of schema. These schema provide the definition of the content of a document. More specifically, all documents that are sent and received by a customer and the managed service provider are wrapped in a document envelope. In one embodiment, all messages sent from or received by the customer and the managed services provider are sent via HyperText Transport Protocol over Secure Socket Layer (HTTs) posts.

Additionally, the well defined third party service provider interface includes a plurality of schema. These schema provide the definition of the content of a document. More specifically, all documents that are sent and received by a third party service provider and the managed service provider are wrapped in a document envelope. In one embodiment, all messages sent from or received by the third pary service provider and the managed services provider are sent via HyperText Transport Protocol over Secure Socket Layer (HTTs) posts.

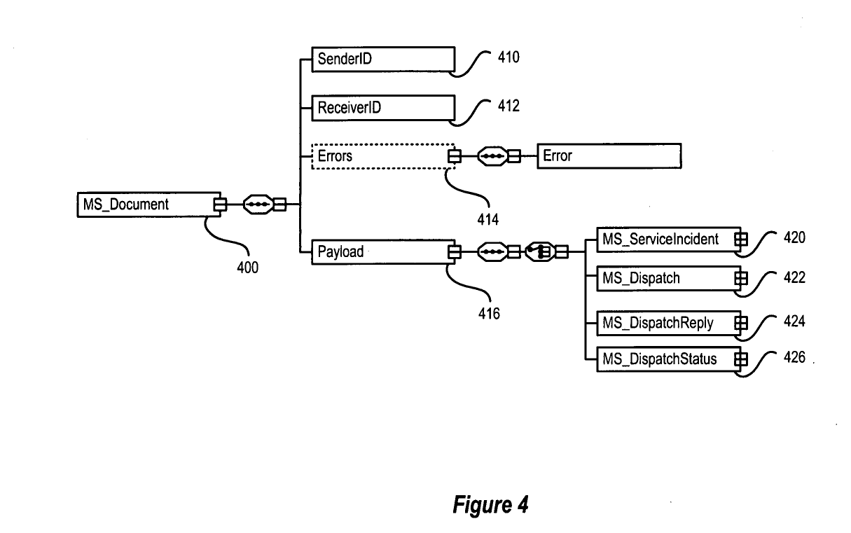

FIG. 4 shows a block diagram of a managed services document envelope schema. More specifically, the managed services document 400 includes a SenderID tag 410, a ReceiverID tag 412, an optional Error tag 414 and a Payload tag 416. The Payload tag 416 includes the actual payload of the document. The payload of the document includes a service incident portion 420, a dispatch portion 422, a dispatch reply portion 424, and a dispatch status portion 426.

The SenderID tag 410 and the ReceiverID tag 412 are used to identify the sender and receiver of the document 400. When a customer sends documents, the SenderID tag contains an identifier which identifies the customer and the ReceiverID tag contains an identifier identifying the managed service provider. If an error occurs when receiving or processing a document, the Errors tag is added to the document and the document is returned to the sender.

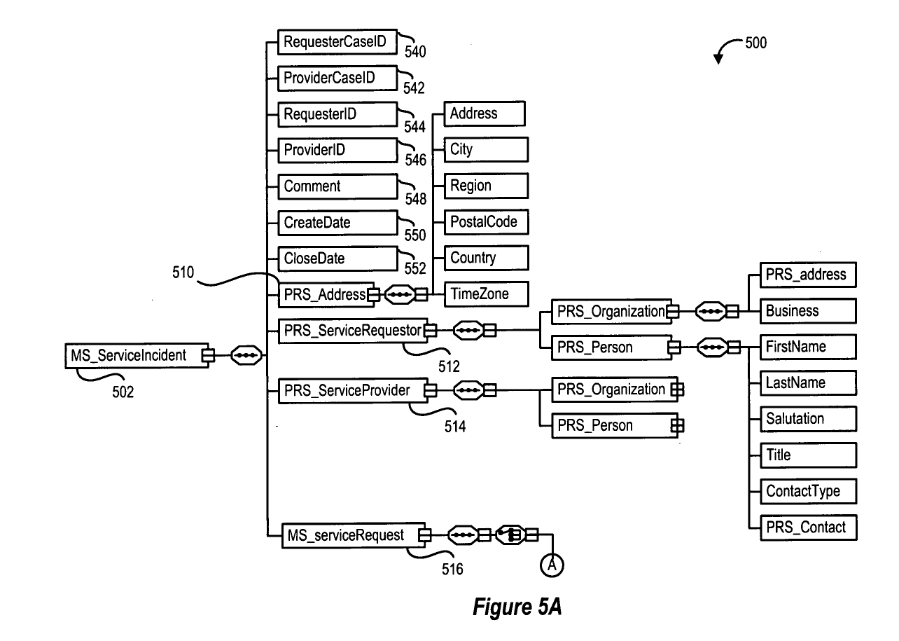

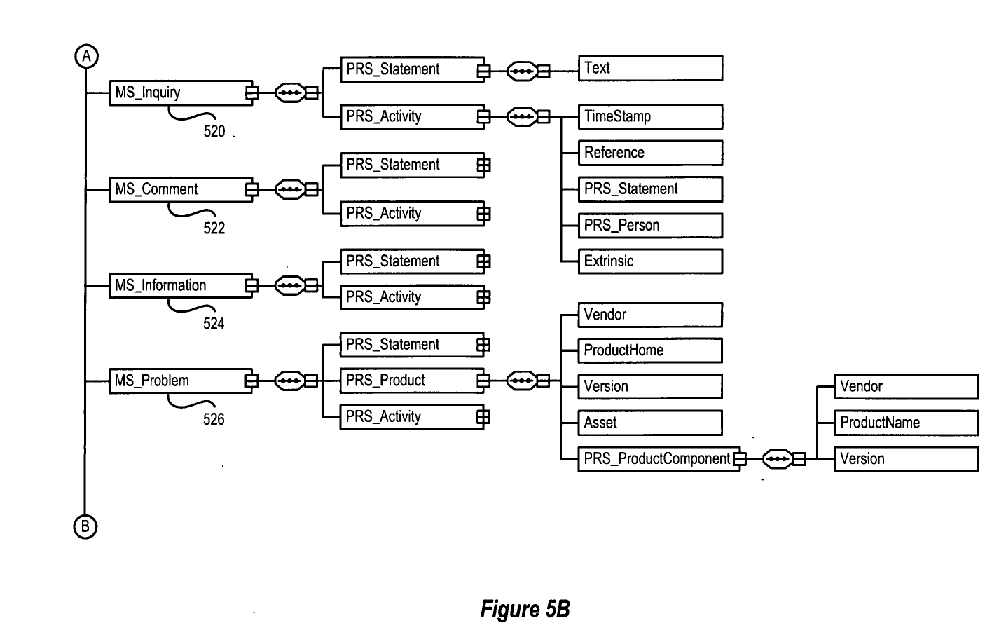

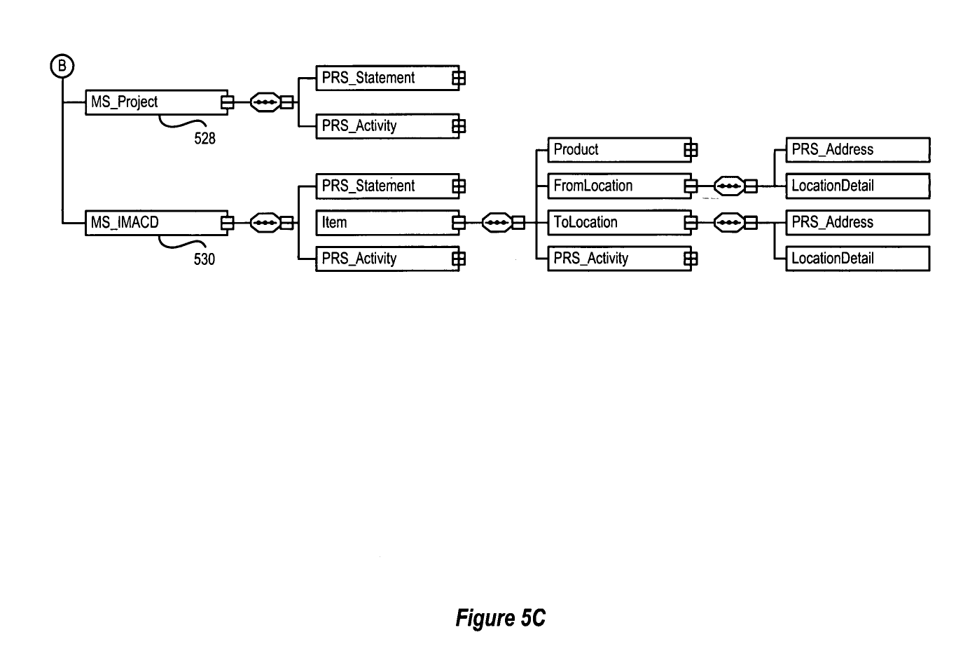

Referring to FIG. 5, a block diagram of a managed services service incident schema 500 is shown. The managed services incident schema 500 is one example of an implementation of the service incident portion 420. The managed services service incident schema substantially conforms to the Distributed Management Task Force (DMTF) Service Incident specification as defined by the Distributed Management Task Force, Inc. of Portland, Oreg. The service incident schema is used to instantiate a Service Incident. The instantiated Service Incident is an object that describes a complete service incident. The activity tags within a service request portion of the Service Incident object describe various events that occur for a service incident.

More specifically, the managed services service incident schema 500 sets forth a corresponding MS_ServiceIncident tag 502 which includes a PRS_Address tag 510, which describes where the service incident and possibly dispatch is to occur, a PRS_ServiceRequester tag 512, which describes the organization and person from the customer who is the subject of the service incident, a PRS_ServiceProvider tag 514, which describes the organizations and person from the managed service provider who is handling the incident and a MS_ServiceRequest tag 516, which describes the problem for the service incident. (According to the DMTF specification, PRS stands for Problem Resolution Standard.) The MS_ServiceIncident tag 502 also includes a PRS_Solution tag (not shown), which aggregates information and the resolution for a problem, The service incident is then split into a plurality of request types: a MS_Inquiry type 520, a MS_Comment type 522, a MS_Informaiton type 524, a MS_Problem type 526, a MS_Project type 528 and a MS_IMACD type 530. The MS_IMACD type 530 indicates whether the request is an installation, move, add, change or dispose request.

In addition to the tags set forth, the MS_ServiceIncident tag 502 includes a plurality of tag elements. More specifically, the MS_ServiceIncident tag 502 includes a ServiceType tag element (not shown), which sets forth the type of service incident, a CurrentStatus tag element (not shown), which sets forth a current status of the service incident, a Severity tag element, which sets forth the severity of the service incident, a Priority tag element, which sets forth the priority of the incident, a Transaction tag element, which sets for the document management transaction. The MS_ServiceIncident tag 502 also includes a RequesterCaseID tag 540, which provides a unique identifier for the incident assigned by the requester, a ProviderCaseID tag 542, which provides a unique identifier for the incident assigned by the provider, a RequesterID tag 544, which provides a unique identifier of the requester organization, a providerID tag 546, which provides a unique identifier of the provider organization, a Comment tag 548, which provides additional general information about the incident, a CreateDate tag, 550, which provider a date the service incident was created, and a CloseDate tag 552, which provides a date the service incident was closed.

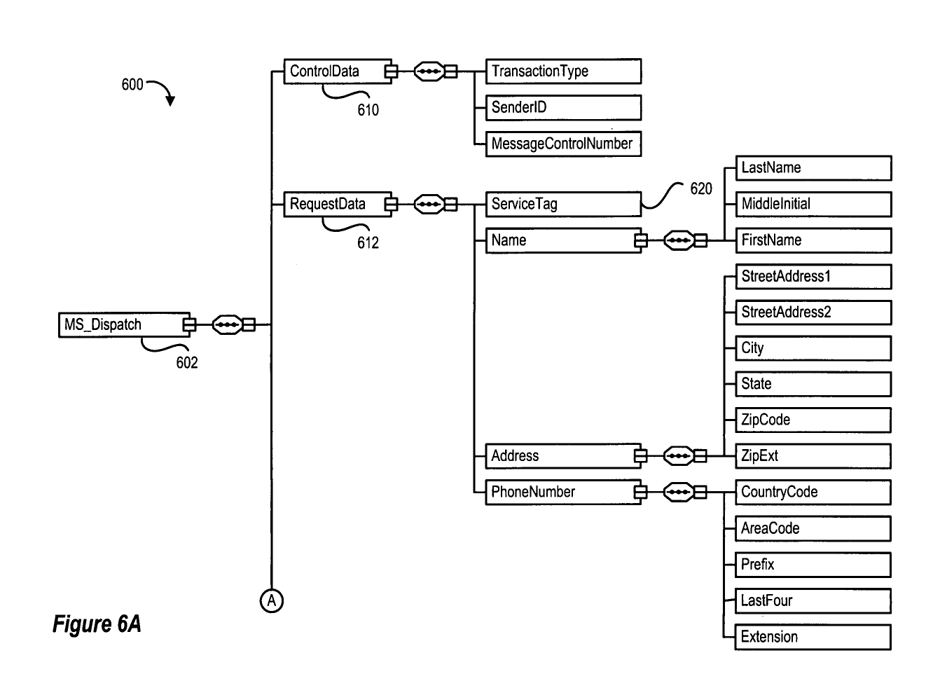

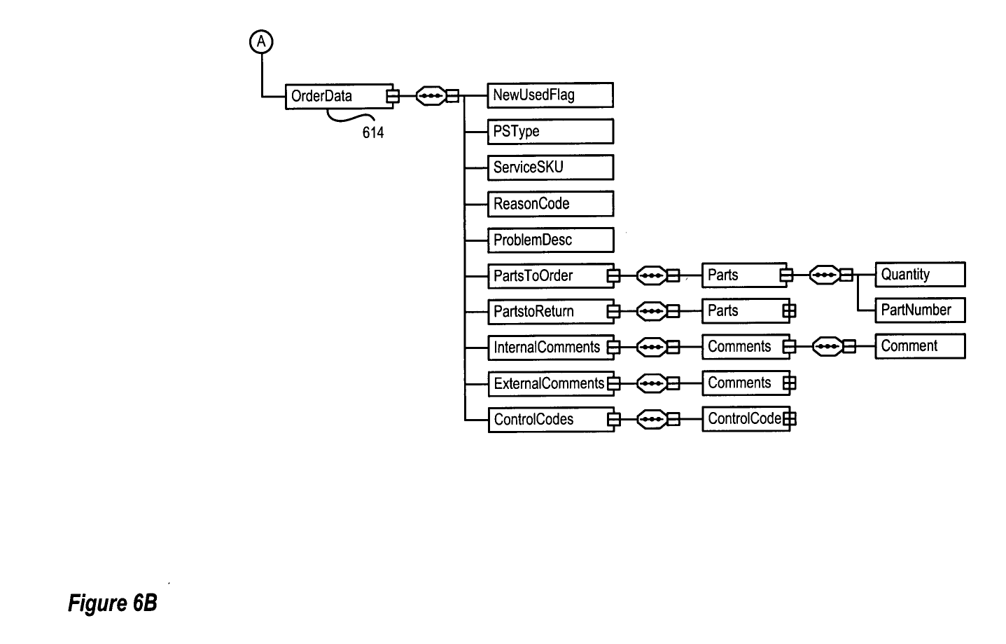

Referring to FIG. 6, a block diagram of a managed services dispatch schema is shown. The managed services dispatch schema 600 is one example of an implementation of the service dispatch portion 422. The managed services dispatch schema substantially conforms to the Distributed Management Task Force (DMTF) Service Incident specification. The managed services dispatch schema 600 is used by a service provider to instantiate and submit a dispatch request to the managed services provider. The instantiated request is an object.

The dispatch schema 600 includes a MS_Dispatch tag 602 which includes a ControlData tag 610, a RequestData tag 612 and an OrderData tag 614. The ControlData tag 610 includes information for identifying the dispatch request. The RequestData tag 612 includes information for identifying the requestor of the dispatch. This information includes a unique system identifier provided by the manufacturer of the system for which the service is to be performed such as a Service Tag which is included within the ServiceTag tag 620. The OrderData tag 614 includes information about parts relating to the dispatch.

The dispatch schema 600 may also optionally include a Problem tag (not shown) which includes information regarding the reason for the dispatch request. The dispatch schema 600 may also optionally include an Asset tag (not shown) which includes information regarding the asset for which the dispatch is requested. This information may include the service tag of the asset as well as other asset identification information such as one or more of the asset type, the asset tag, the asset serial number, the asset make, the asset model, the asset line of business, the warranty of the asset and the warranty period of the asset.

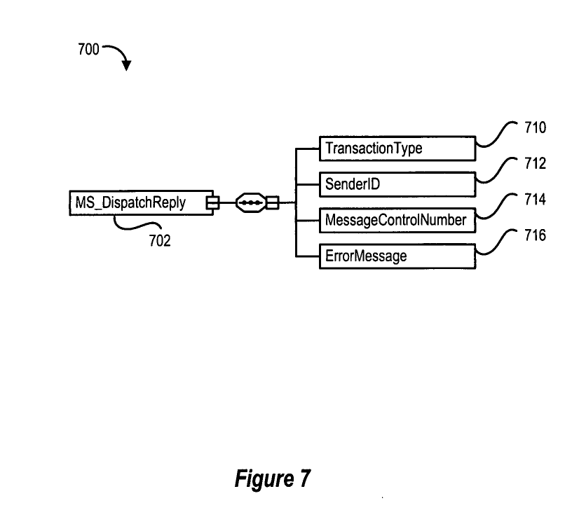

Referring to FIG. 7, a block diagram of a managed services dispatch reply schema 700 is shown. The dispatch reply schema 700 includes a MS_DisptachReply tag 702 which includes a TransactionType tag 710, a SenderID tag 712, a MessageControlNumber tag 714, and an ErrorMessage tag 716. The TransactionType tag 710 identifies whether to forward a dispatch request or to cancel the dispatch request. The SenderID tag 712 provides a customer identifier. The MessageControlNumber tag 714 provides a customer unique a identifier for the request. The ErrorMessage tag 716 provides the name of an error field if an error occurs.

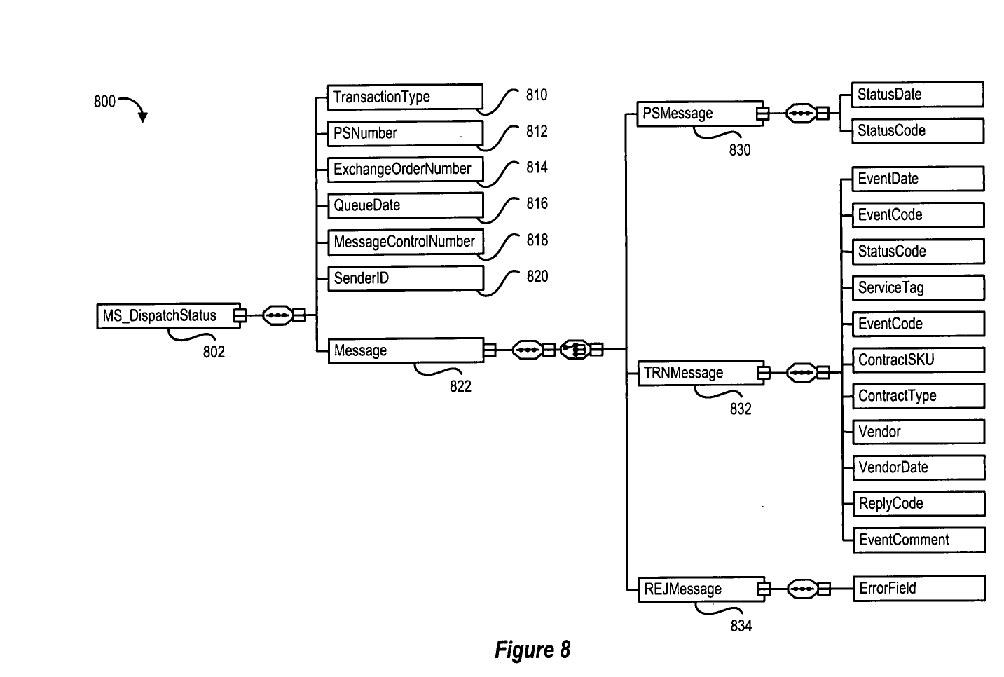

Referring to FIG. 8, a block diagram of a managed services dispatch status schema 800 is shown. The managed services dispatch status schema 800 is used by the managed services provider to provide ongoing status of a dispatch request to a customer. The managed services dispatch status schema 800 includes a MS_DistaptchStatus tag 802 which includes a TransactionType tag 810, a PSNumber tag 812, an ExchangeOrderNumber tag 814, a QueueDate tag 816, a MessageControlNumber Tag 818, a SenderID tag 820 and a Message tag 822. The Message tag 822 further includes a PSMessage tag 830, a TRNMessage tag 832 and a REJMessage tag 834.

The TransactionType tag 810 identifies whether the transaction is a dispatch request or a cancel dispatch request. The PSNumber tag 812 identifies the managed services provider dispatch number. The ExchangeOrderNumber tag 814 is the exchange number for the part that was replaced. The QueueDate tag 816 identifies the date and time of the original request for dispatch. The MesageControlNumber tag 818 provides a customer unique identifier for the request. The SenderID tag 820 provides the customer identifier. The Message tag 822 includes one of three submessages. The PSMessage tag 830 provides a status message area. The TRNMessage tag 832 provides a transaction history message area. The REJMessage tag 834 provides a dispatch reject message area.

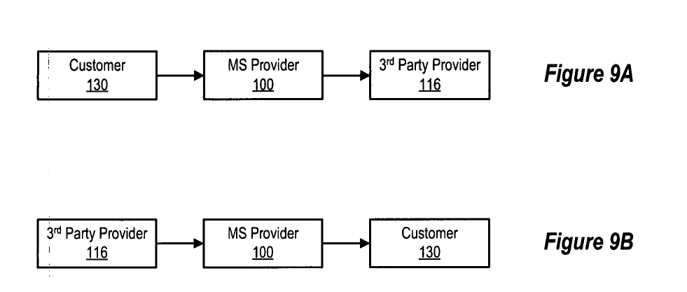

Referring to FIGS. 9A and 9B, block diagrams of service document flow are shown. More specifically, the system for managing services 100 provides a proxy between customers 130 and third party service providers 116 for all service incident documents. All messages are sent to the managed services provider and then redirected to the intended recipient via individual service incident documents.

For example, referring to FIG. 9A, a customer 130 sends a service incident document to the managed services provider 100. The managed services provider 100 then determines to which third party service provider 116 to forward the document based upon the contents of the service incident. The managed services provider 100 then forwards the document to the appropriate third party service provider 116. Also for example, referring to FIG. 9B, a third party service provider 116 sends service incident documents to the managed services provider. The managed services provider determines to which customer to forward the document (e.g., based upon the PRS_ServiceReqeustor tag). The managed services provider then forwards the document to the appropriate customer 130.

### Other Embodiments

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

1. A method for separating labor services from a managed service provider comprising:
providing the managed service provider with a service collaboration manager;
interfacing with a service customer via the service collaboration manager;
interfacing with a labor service provider via the service collaboration manager; and
separating the labor service provider from the service collaboration manager.

2. The method of claim 1 wherein:
the interfacing with a service customer is via a well defined interface; and
the managed service provider maintains control over the well defined interface.

3. The method of claim 1 wherein:
the interfacing with a service customer includes routing data to and from the service customer; and,
the managed service provider maintains control over the routing of data via the service collaboration manager.

4. The method of claim 1 wherein:
the interfacing with a third party service provider is via a well defined interface; and
the managed service provider maintains control over the well defined interface.

5. The method of claim 1 wherein:
the interfacing with a third party service provider includes routing data to and from the third party service provider; and,
the managed service provider maintains control over the routing of data via the service collaboration manager.

6. The method of claim 1 further comprising:
reducing labor to be performed into discrete repeatable tasks.

7. The method of claim 6 further comprising:
assigning the discrete repeatable tasks among multiple labor service providers.

8. The method of claim 6 further comprising:
supporting a diversified set of service suppliers to service a particular customer by identifying repeatable services and tasks within the managed service provider.

9. The method of claim 6 further comprising:
assigning labor service providers on a transaction basis, the transaction basis corresponding to the discrete repeatable tasks.

10. The method of claim 1 wherein:
the interfacing with the service customer includes a plurality of parallel workstreams.

11. The method of claim 1 wherein:
the interfacing with the labor service provider includes a plurality of parallel workstreams.

12. The method of claim 1 further comprising:
coordinating work across multiple labor service providers via the service collaboration manager.

13. The method of claim 12 wherein:
the coordinating work across multiple labor service providers includes communicating with the plurality of labor service providers via a plurality of parallel workstreams.

14. The method of claim 12 wherein:
the coordinating work across multiple labor service providers is based upon a labor service provider determinator.

15. The method of claim 14 wherein:
the labor service provider determinator includes at least one of labor service provider cost, labor service provider geographic location, labor service provider skill set, labor service provider language, and customer preference.

16. An apparatus for separating labor services from a managed service provider comprising:
means for providing the managed service provider with a service collaboration manager;
means for interfacing with a service customer via the service collaboration manager;
means for interfacing with a labor service provider via the service collaboration manager; and
means for separating the labor service provider from the service collaboration manager.

17. The apparatus of claim 16 wherein:
the means for interfacing with a service customer is via a well defined interface; and
the managed service provider maintains control over the well defined interface.

18. The apparatus of claim 16 wherein:
the means for interfacing with a service customer includes means for routing data to and from the service customer; and,
the managed service provider maintains control over the routing of data via the service collaboration manager.

19. The apparatus of claim 16 wherein:
the means for interfacing with a third party service provider is via a well defined interface; and
the managed service provider maintains control over the well defined interface.

20. The apparatus of claim 16 wherein:
the means for interfacing with a third party service provider includes means for routing data to and from the third party service provider; and,
the managed service provider maintains control over the means for routing of data via the service collaboration manager.

21. The apparatus of claim 16 further comprising:
means for reducing labor to be performed into discrete repeatable tasks.

22. The apparatus of claim 21 further comprising:
means for assigning the discrete repeatable tasks among multiple labor service providers.

23. The apparatus of claim 21 further comprising:
means for supporting a diversified set of service suppliers to service a particular customer by identifying repeatable services and tasks within the managed service provider.

24. The apparatus of claim 21 further comprising:
means for assigning labor service providers on a transaction basis, the transaction basis corresponding to the discrete repeatable tasks.

25. The apparatus of claim 16 wherein:
the means for interfacing with the service customer includes a plurality of parallel workstreams.

26. The apparatus of claim 16 wherein:
the means for interfacing with the labor service provider includes a plurality of parallel workstreams.

27. The apparatus of claim 16 further comprising:
means for coordinating work across multiple labor service providers via the service collaboration manager.

28. The apparatus of claim 27 wherein:
the means for coordinating work across multiple labor service providers includes means for communicating with the plurality of labor service providers via a plurality of parallel workstreams.

29. The apparatus of claim 27 wherein:
the means for coordinating work across multiple labor service providers is based upon a labor service provider determinator.

30. The apparatus of claim 29 wherein:
the labor service provider determinator includes at least one of labor service provider cost, labor service provider geographic location, labor service provider skill set, labor service provider language, and customer preference.
